(19) United States
(12) Patent Application Publication
(10) Pub. No.: US 2009/0219261 A1
(43) Pub. Date: Sep. 3, 2009

(54) Touch-Sensitive Illuminated Display Apparatus and Method of Operation Thereof

(76) Inventors: Joseph Jacobson, Newton, MA (US); Serge Rutman, Boulder Creek, CA (US); Jun-Bo Yoon, Yuseong-gu (KR)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 12/332,860

(22) Filed: Dec. 11, 2008

Related U.S. Application Data
(60) Provisional application No. 61/012,869, filed on Dec. 11, 2007.

(51) Int. Cl. G06F 3/042

(52) U.S. Cl. 345/175; 178/18.09

(57) ABSTRACT

A touch-sensitive system, and apparatus, and method of operation of the apparatus, are provided. In one embodiment, the apparatus includes a light source module configured to emit light; and a deformable waveguide coupled to the light source module and configured to transmit the light or a deflected version of the light at a situs at which pressure external to the deformable waveguide is applied. The deformable waveguide may also be illuminated by the light. The apparatus may also include one or more sensors configured to detect information indicative of the light or the deflected version of the light at the situs, and output a signal in response to the detected information.

### CROSS-REFERENCE TO RELATED APPLICATIONS

This application claims priority to and the benefit of U.S. provisional patent application No. 61/012,869 titled “Touch Sensitive Illuminated Display,” which was filed on Dec. 11, 2007, the contents of which are incorporated herein by reference in its entirety.

### FIELD OF THE INVENTION

The present invention relates to display apparatus, in general, and touch-sensitive illuminated display apparatus, in particular.

### BACKGROUND INFORMATION

Conventional displays, such as liquid crystal displays (LCDs), are typically transparent. The displays are positioned over conventional illumination units (CIUs), such as backlight units, which transmit light through the display panels to provide an image viewable by the user. However, conventional CIUs, which include light guide plates (LGPs), are disadvantageously excessive in weight. The excessive weight is largely due to the multiple optical sheets typically included in the fabrication of the LGP. Single-sheet LGPs with no additional films have been developed that reduce the weight of and simply the fabrication of the CIU. These LGPs are advantageously lightweight.

In electronic phoretic displays (EPDs), such as electronic paper, the display panel is not transparent. Accordingly, conventional techniques of providing an EPD display panel positioned over a CIU may not provide enough light to allow the user to easily view the EPD. Therefore, alternate systems, apparatus and methods for lighting the EPD are desirable.

Additionally, with the increase in the number of technology-driven consumer products, there is a strong desire to enhance user interactivity with EPDs. One approach to enhancing user interactivity is to provide touch-sensitive devices. However, the desire to illuminate devices such as EPDs persists. Accordingly, it is desirable to have lightweight, illuminated, touch-sensitive display systems and apparatus, along with methods of operation thereof.

### BRIEF DESCRIPTION OF THE DRAWINGS

Purposes and scope of exemplary embodiments described below will be apparent from the following detailed description in conjunction with the appended drawings in which like reference characters are used to indicate like elements, and in which:

FIG. 1 is a perspective view and a cross-sectional view of a conventional illumination unit (CIU) with a single-sheet LGP;

FIGS. 2A and 2B are schematic diagrams of a touch-sensitive system in accordance with an embodiment of the invention;

FIG. 2C is a flow diagram of screenshots illustrating the structure and functionality of a prototype of an embodiment of the invention;

FIG. 3 is a cross-sectional view of a touch-sensitive display apparatus of the touch-sensitive system of FIG. 2B;

FIG. 4 is a schematic diagram of a touch-sensitive display apparatus in accordance with another embodiment of the invention;

FIG. 5 is a flow diagram of a method of operating a touch-sensitive display apparatus in accordance with embodiments of the invention; and

FIG. 6 is a diagram of circuitry in accordance with embodiments of the invention.

### SUMMARY OF EMBODIMENTS OF THE INVENTION

In one embodiment, a touch-sensitive apparatus is provided. The apparatus may include a light source module configured to emit light; and a deformable waveguide coupled to the light source module and configured to transmit the light or a deflected version of the light. The light or the deflected version of the light may be received at a situs at which pressure external to the deformable waveguide is applied. The deformable waveguide may also be illuminated by the light. The apparatus may also include one or more sensors configured to detect information indicative of the light or the deflected version of the light at the situs, and output a signal in response to the detected information.

In another embodiment, a touch-sensitive system is provided. The system may include a touch-sensitive apparatus. The apparatus may include a light source module configured to emit light; and a deformable waveguide coupled to the light source module and configured to transmit the light or a deflected version of the light. The light or the deflected version of the light may be received at a situs at which pressure external to the deformable waveguide is applied. The deformable waveguide may also be illuminated by the light. The apparatus may also include one or more sensors configured to detect information indicative of the light or the deflected version of the light at the situs, and output a signal in response to the detected information. The system may also include a signal processor configured to receive the signal output by the one or more sensors and identify the situs; and a display device configured to provide a visual display indicative of the identified situs.

In another embodiment, a method of operating a touch-sensitive apparatus having a light source module, a deformable waveguide coupled to the light source module, and one or more sensors coupled to the deformable waveguide is provided. The method may include: emitting light from the light source module; transmitting, through the deformable waveguide, light or a deflected version of the light at a situs at which external pressure is applied to the deformable waveguide. The method may also include: detecting, at the one or more sensors, information indicative of the light or the deflected version of the light at the situs; and outputting, from the one or more sensors, a signal in response to the detected information.

### DETAILED DESCRIPTION OF EMBODIMENTS OF THE INVENTION

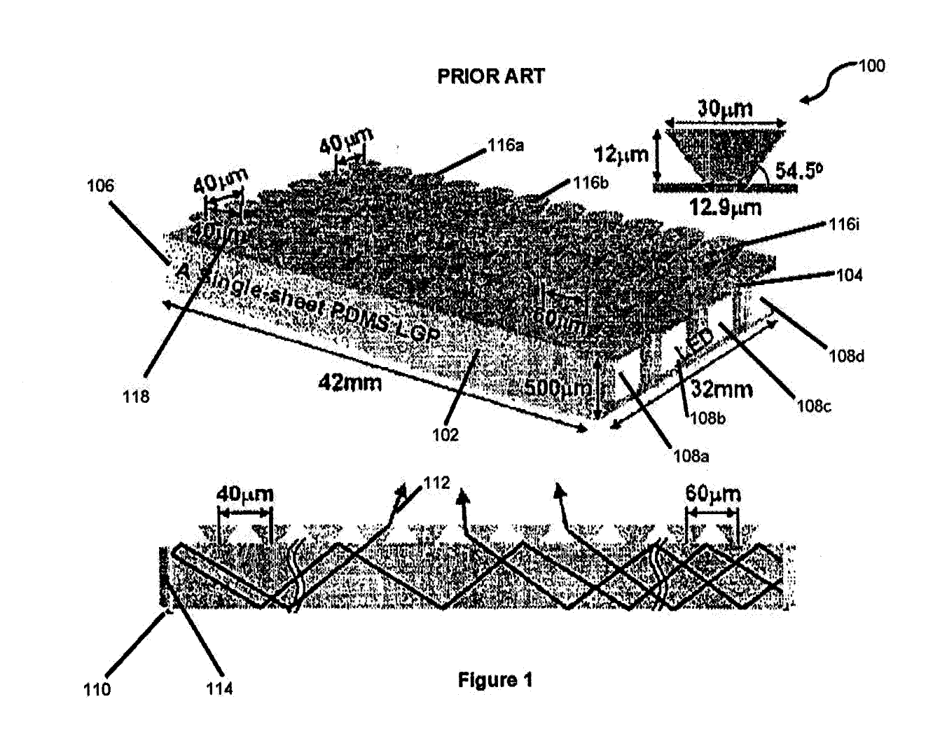

FIG. 1 shows a perspective and a cross-sectional view of a conventional illumination unit (CIU) with a single-sheet LGP. The CIU shown is as described in “Simple Liquid Crystal Display Backlight Unit Comprising Only A Single-Sheet Micropatterned Polydimethylsiloxane (PDMS) Light-Guide Plate,” Optics Letters, vol. 32, no. 18, Sep. 15, 2007 (“LGP Publication”), the entire content of which is incorporated herein by reference. Specifically, with reference to FIG. 1, the CIU 100 includes an LGP 102 formed of a single sheet of PDMS with no additional optical films. The LGP 102 is fabricated to include a micropattern of inverted trapezoids 116a, 116b, . . . 116i imposed on the LGP 102. The pattern of the inverted trapezoids 116a, 116b, . . . 116i may be formed using the LightTools® illumination design program. Each of the inverted trapezoids has a top diameter of 30 μm, a bottom diameter of 12.9 μm, a height of 12 μm and an inclined angle of 54.5 degrees. The distance between inverted trapezoids is 40 μm. The LGP includes a first end 104 coupled to light-emitting diodes (LEDs) 108a, 108b, 108c, 108d and a second end 106 that coupled to a mirror 110. The height, width and length of the LGP is 500 μm, 32 mm and 42 mm, respectively.

The LEDs 108a, 108b, 108c, 108d emit light 112 that is reflected, according to total internal reflection, out of the LGP 102 after reflecting one or more times from the interior surfaces of the LGP 102. The light 112 is edge-injected into the LGP 102 due to the location of the LEDs 108a, 108b, 108c, 108d on the edge of the LGP 102. The mirror 110 has a reflective surface 114 positioned opposite the LEDs 108a, 108b, 108c, 108d to reflect the light 112. The light 112 is ejected from the LGP 102 at the inclined sidewall of the inverted trapezoids 116a, 116b, . . . 116i. The LGP 102 is fabricated according to the manufacturing process described in the LGP Publication.

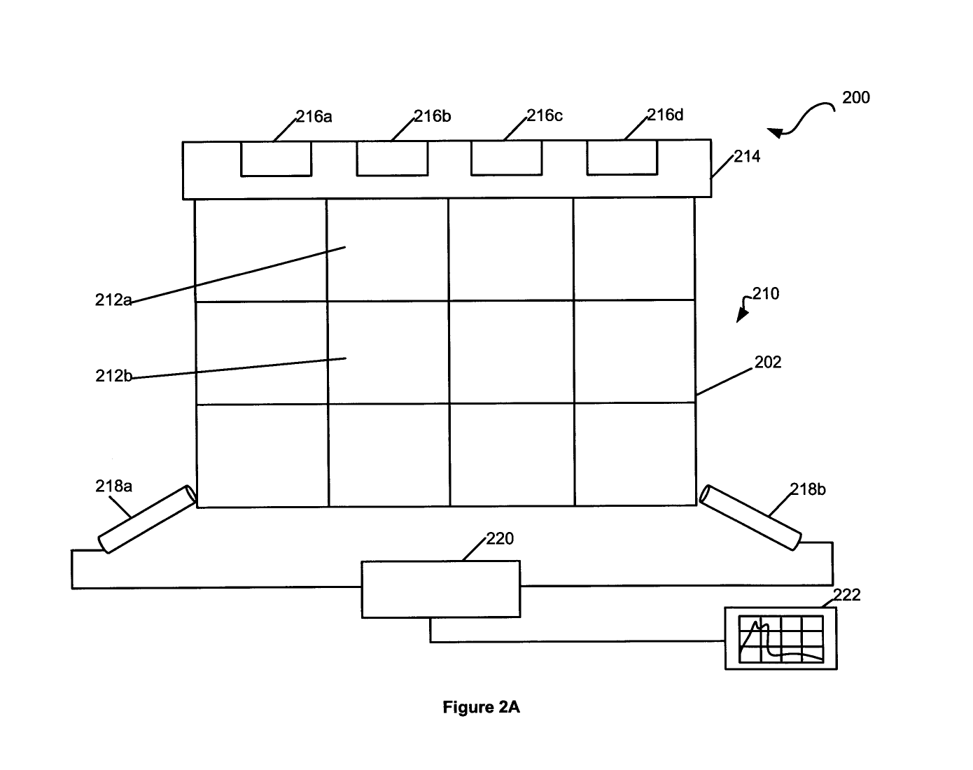

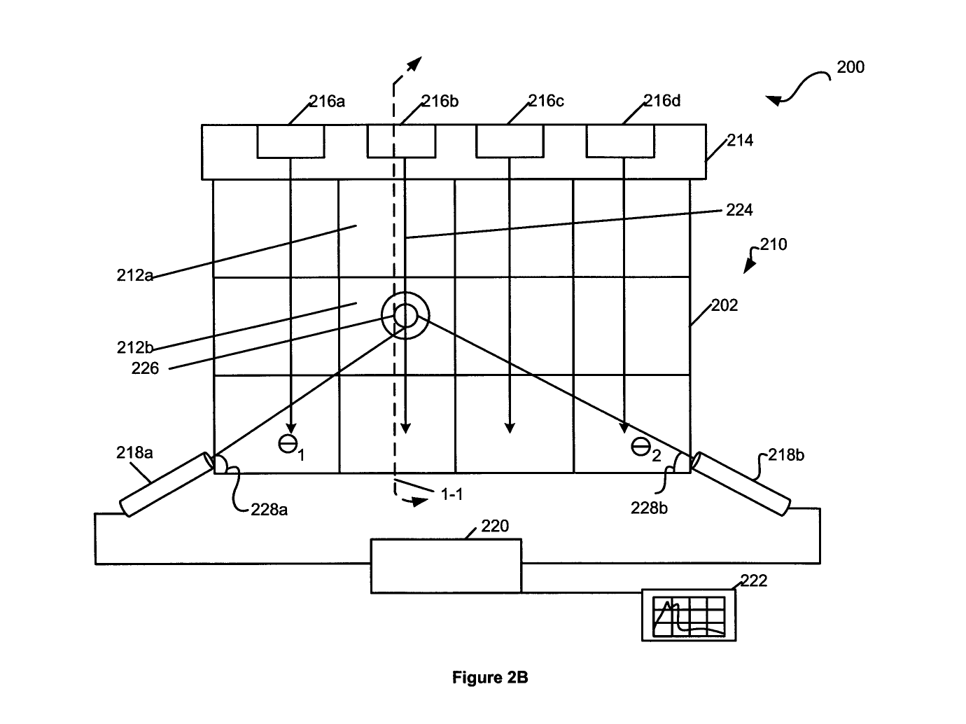

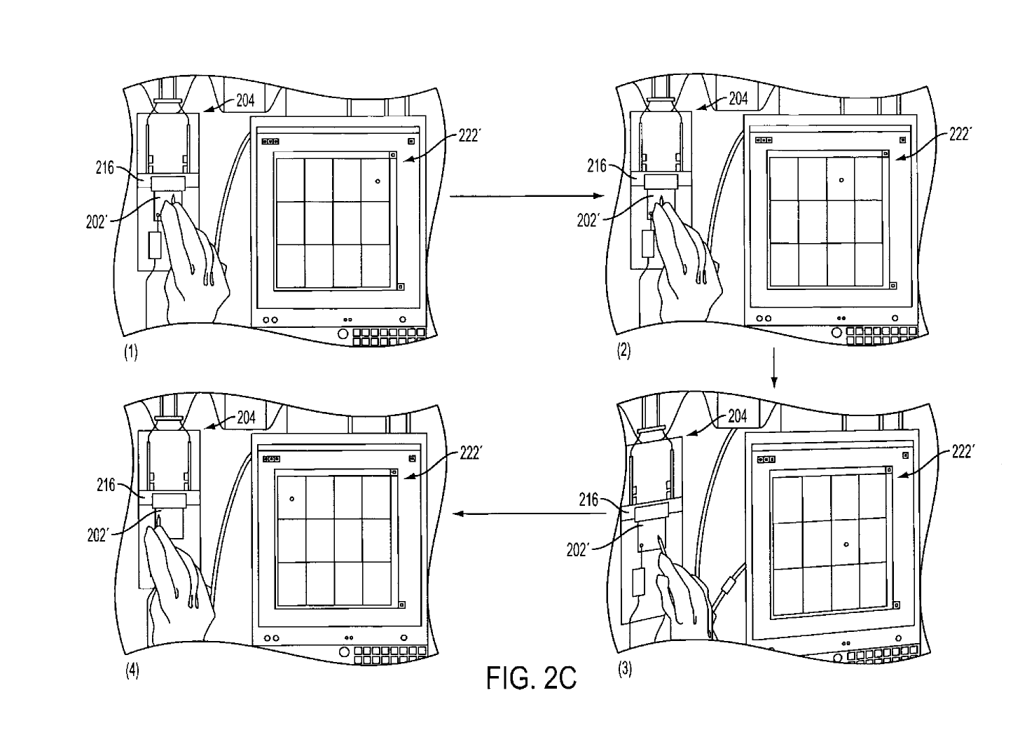

In exemplary embodiments of the invention, touch-sensitive systems, display apparatus and methods of operation of the display apparatus are provided. In various embodiments of the invention, a CIU such as that described in the LGP Publication may be modified to provide touch-sensitive systems, display apparatus and methods of operation of the display apparatus, as described with reference to FIGS. 2A, 2B, 3, 4 and 5.

While the CIU as described in the LGP Publication is positioned under a transparent display panel for providing backlighting of the display panel, the various embodiments of the invention may include a touch-sensitive front light unit (T-FLU) having one or more components positioned over (i.e., on top of) an EPD for providing front lighting for the EPD. The CIU 100 described with reference to FIG. 1 may be modified and utilized for such front lighting as described below. Additionally, while specific dimensions of the CIU 100 have been provided in the description with reference to FIG. 1, and one or more such dimensions may be used in embodiments of the T-FLU, other embodiments having other dimensions may also be used. Additionally, while PDMS has been described with regard to the CIU, and the T-FLU may include such material, other embodiments of the T-FLU may include other materials. In various embodiments, any other transparent or substantially transparent plastic or other flexible material may be used. Finally, while inverted trapezoids have been described with regard to the micropattern of the LGP of the CIU, and the micropattern of the T-FLU may be formed with such shapes, many other variations in the micropattern are possible. All such alternatives and variations are envisaged by the inventors and encompassed within the scope of the embodiments disclosed herein, including as described in the claims.

FIGS. 2A and 2B are schematic diagrams of a touch-sensitive system in accordance with an embodiment of the invention. In one embodiment, the system 200 may include a touch-sensitive front light unit (T-FLU) 210, a signal processor 220 and a display device 222. The T-FLU 210 may be communicatively coupled to the signal processor 220 and the signal processor 220 may be communicatively coupled to a display device 222.

In various embodiments, the T-FLU 210 may provide light that may be deflected at a situs at which pressure may be provided from a location external to the T-FLU 210. The deflected light may be detected by the T-FLU 210 and one or more signals may be output from the T-FLU 210 based on the detected information. The one or more signals may be received and processed by the signal processor 220.

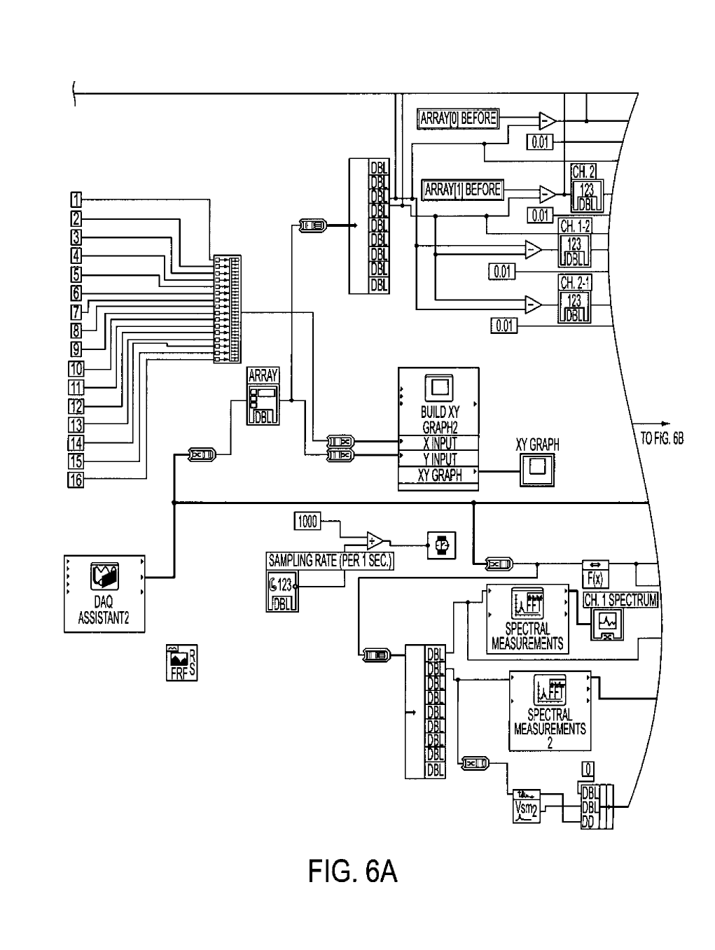

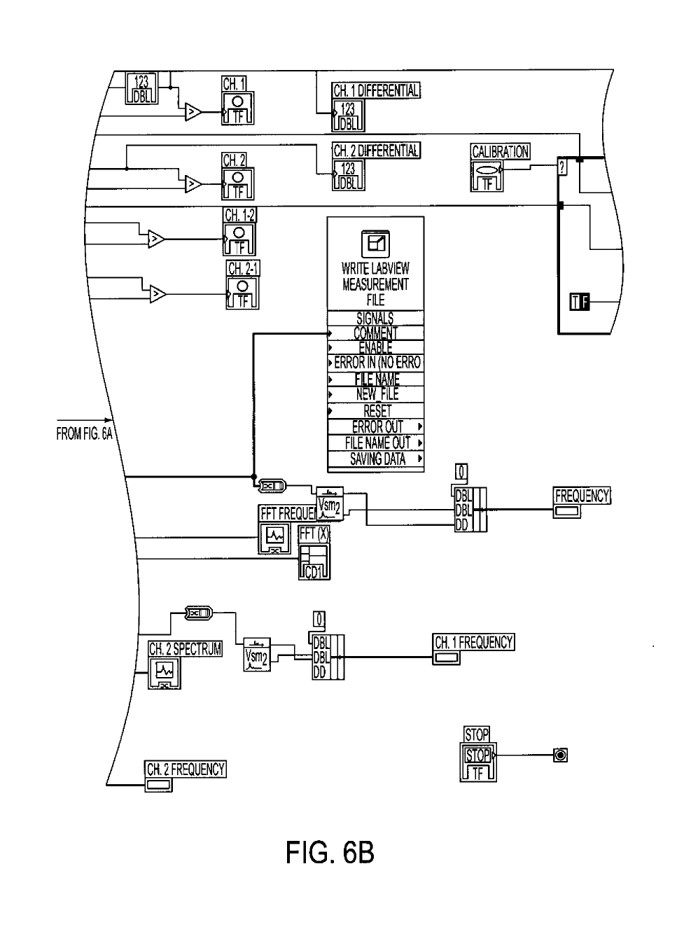

In various embodiments, the signal processor 220 may process the signals for any number of different types of information. By way of example, but not limitation, the signal processor 220 may process the signal to determine the situs and/or the amount of the pressure applied at the situs. The signal may be collected and/or filtered before or after the determination of the situs and/or the amount of pressure applied at the situs. The signal processor 220 may include any software, hardware, including circuitry, to collect information and/or identify the situs and/or the amount of pressure applied to the T-FLU 210. FIG. 6 is a diagram of circuitry in accordance with embodiments of the invention. In various embodiments, the signal processor 220 may include signal processing algorithms and/or selected circuitry such as that shown in FIG. 6 for identification of the situs and/or measurement of an amount of applied pressure. In some embodiments, such algorithms may be well-known in the art. In one embodiment, the signal processing algorithms may be those implemented in the National Instruments® NI-DAQmx module, National Instruments® NI-DAQ module, National Instruments® DAQ module and/or the National Instruments® DAQ Assistant module. The processed information may be output from the signal processor 220 and received by the display device 222.

In some embodiments, the display device 222 may be any device configured to provide a display corresponding to the information output from the signal processor 220. In some embodiments, the display device 222 may operate according to algorithms by which the National Instruments® LabVIEW module operates. In various embodiments, the display device 222 may include and/or operate according to the circuitry shown in FIG. 6.

In other embodiments, the system 200 may include only a T-FLU 210 and a signal processor 220 for processing the signals received from the T-FLU 210. The signal processor 220 may output the processed signals to any number of components that may be included in the system for providing various applications. For example, the signals may be output to a controller for controlling the operation of an EPD device (not shown) or any other device to which the T-FLU 210 may be communicatively coupled. By way of example, but not limitation, the device may be any wired or wireless device in any number of environments including, but not limited to, mobile, internet, automobile, home networking, and/or home alarm environments. In various embodiments, the device may be electronic paper, an e-book reader, a television, a telephone, a personal digital assistant (PDA), a personal computer, a laptop, a home alarm system, an automobile navigation system or the like.

Exemplary embodiments of the T-FLU 210 will now be described in detail. The T-FLU 210 may include a waveguide 202, a light source module 214 and one or more sensors 218a, 218b. The waveguide 202 may be coupled to the light source module 214 such that light emitted from the light source module 214 may travel into the waveguide 202. The light source module 214 may be edge-mounted to the waveguide 202 (and/or to the EPD or other display) in varous embodiments to provide edge-injected light 214 into waveguide 202. The sensors 218a, 218b may be operably coupled to and positioned along the waveguide 202 such that one or more of the light emitted into the waveguide 202 may be detected.

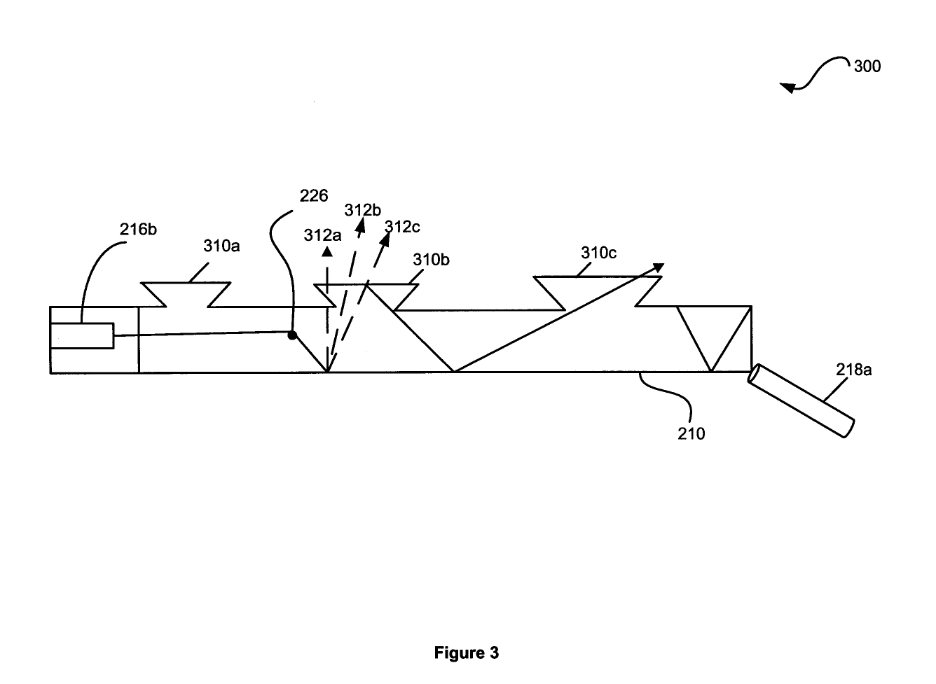

With reference to FIGS. 2A and 3, in one embodiment, the waveguide 202 may include deformable material in some embodiments. Further, in some embodiments, the waveguide 202 may include a micropattern formed on a top surface of the waveguide 202. The micropattern may include of inverted trapezoids 310a, 310b, 310c in some embodiments. In other embodiments, the micropattern may include other shapes as determined by the apparatus and/or system designer. In some embodiments, the waveguide 202 may be formed of the single sheet of the deformable material with no additional optical films. The deformable material may be any material able to be deformed with the application of an amount of pressure typical of that which is typically provided by a human finger or device manipulated by a human. In one embodiment, the waveguide 202 may be formed of a single sheet of PDMS as described with reference to FIGS. 1A and 1B. In other embodiments, as noted above, any transparent or substantially transparent plastic or flexible material may be used.

Referring to FIGS. 2A and 2B, in the T-FLU 210 shown, four light sources 216a, 216b, 216c, 216d, and two sensors 218a, 218b are provided. In this embodiment, the T-FLU 210 may have a sensing area that may be virtually divided into any number of areas 212a, 212b of a grid. In the example shown, the T-FLU is virtually divided into a 3 row×4 column grid. In other embodiments, the T-FLU 210 may be a grid of any number of rows and columns as dictated by the number of light sources and the number of sensors of the T-FLU 210. As the number of rows and/or columns of the grid of the T-FLU 210 increases, the resolution of the T-FLU 210 may increase. Accordingly, the different embodiments of the T-FLU 210 may be designed to achieve selected resolutions suitable for different applications. For example, a video game application may require lower resolution than a virtual drafting application.

Each sensor 218a, 218b may create a sensing channel that may cover an area that may be detected by the respective sensor. For example, the sensors 218a, 218b may be mounted on respective lower side corners of the waveguide 202. The arrangement may create two channels over which sensing on the waveguide 202 are performed. In this arrangement, mounting the sensors 218a, 218b on the sides of the waveguide 202 may reduce the likelihood that the light from the light sources 216a, 216b, 216c, 216d will saturate the sensors 218a, 218b.

In some embodiments, the light source module 214 may include a plurality of light sources 216a, 216b, 216c, 216d configured to emit light such as the light 224 emitted from light source 216b. In some embodiments, the light source module 214 may be or include a single discrete unit or an array of light sources 216a, 216b, 216c, 216d. In some embodiments, the light source module 214 may be any source configured to emit light. In various embodiments, the light sources 216a, 216b, 216c, 216d may be any mechanism configured to emit light that may be detected by sensors 218a, 218b. By way of example, but not limitation, one or more of the light sources 216a, 216b, 216c, 216d may be a source that provides light that is visible or invisible to the human eye including, but not limited to, an LED, an infrared light source, an incandescent light, a fluorescent lamp, and/or an electroluminescent panel.

The light source module 214 and/or one or more of the light sources 216a, 216b, 216c, 216d may emit light injected into the waveguide 202 and that travels through the waveguide 202. The light may be reflected from the micropattern of the waveguide 202 toward a display, including, but not limited to, an EPD, over which the T-FLU 210 may be positioned. The light may be reflected from the display and may travel through the waveguide 202. Accordingly, the light may illuminate the display, and the light traveling through the waveguide 202 may travel toward a user using the display.

In one embodiment, the sensors 218a, 218b may be photodetectors such as photodiodes. The sensors 218a, 218b may be positioned at any location along the periphery of the waveguide 202 such that the sensors are able to detect the light emitted by the light sources 216a, 216b, 216c, 216d. Accordingly, the position of the sensors 218a, 218b may differ across embodiments based on the aspect ratio of the waveguide 202. In various embodiments, sensors 218a, 218b may be positioned at any number of angles 228a, 228b relative to the base of the waveguide 202 such that one or more of the sensors can sense light 224. In the embodiment shown, the angles 228a, 228b at which sensors 218a, 218b may be positioned may be any angle between approximately 5 degrees and 90 degrees.

The sensors 218a, 218b and/or the signal processor 220 may be able to normalize the non-uniform light that may be injected into the waveguide 202 and provide a substantially uniform output indicative of the situs and/or the measurement of the applied pressure.

FIG. 3 is a cross-sectional view of a touch-sensitive display apparatus of the touch-sensitive system of FIG. 2B. FIG. 3 shows the cross-sectional view of the internal reflections in the T-FLU 210 along line 1-1 of FIG. 2B. Referring to FIGS. 2B and 3, in the embodiment shown, light sources 216a, 216b, 216c, 216d emit light. External pressure is applied to the T-FLU 210 at a selected situs 226, which corresponds to a selected grid section 212b of the waveguide 202. The pressure interrupts the light 224 emitted by light source 216b thereby causing a change in the intensity of the light and causing the light to deflect into a number of directions. The deflected light 312a, 312b, 312c may be ejected from the inclined sidewall of the inverted trapezoid 310b of the waveguide 202. The deflected light 312a, 312b, 312c may be stronger at locations on the waveguide 202 closer to the situs 226 and weaker at locations further from the situs 226.

The change in intensity and/or the angle of travel of the light and/or the deflected light 312a, 312b, 312c may be detected by the sensors 218a, 218b. The sensors 218a, 218b may convert the intensity and/or change in intensity of the light 224 to a signal, and output the signal from the T-FLU 210 to the signal processor 220. The signal processor 220 may process the signal to identify the situs 226 and/or the amount of pressure applied at the situs 226. In some embodiments, the signal processor 220 may output the processed signal to a display device 222.

FIG. 2C is a flow diagram of screenshots illustrating the structure and functionality of a prototype of an embodiment of the invention. The prototype includes a T-FLU 204 communicatively coupled to a signal processor (not shown) and a display device 222′. As shown in the flow diagram, the application of pressure external to the waveguide 202′ may cause edge-injected light into the waveguide 202′ from the light sources 216′ to deflect at the location of the situs. The light and deflected versions of the light may be detected by sensors (not shown) on the T-FLU 204 and a signal indicative of the situs and/or the amount of pressure applied may be processed, and the processed information may be displayed by the display device 222′. As shown, a grid location of the waveguide 202′ at which the pressure is applied may be displayed on the display device 222′.

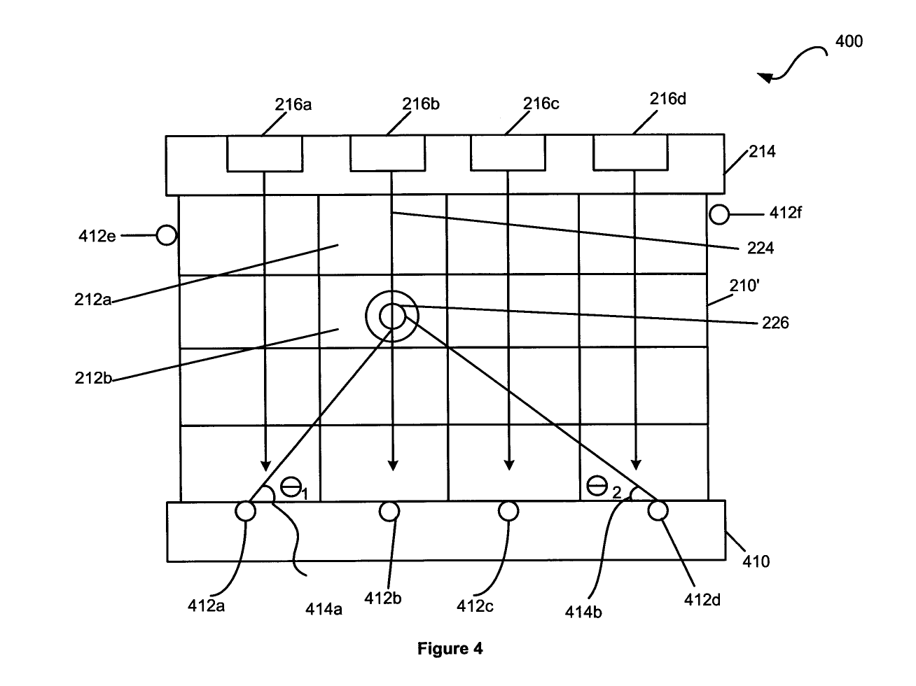

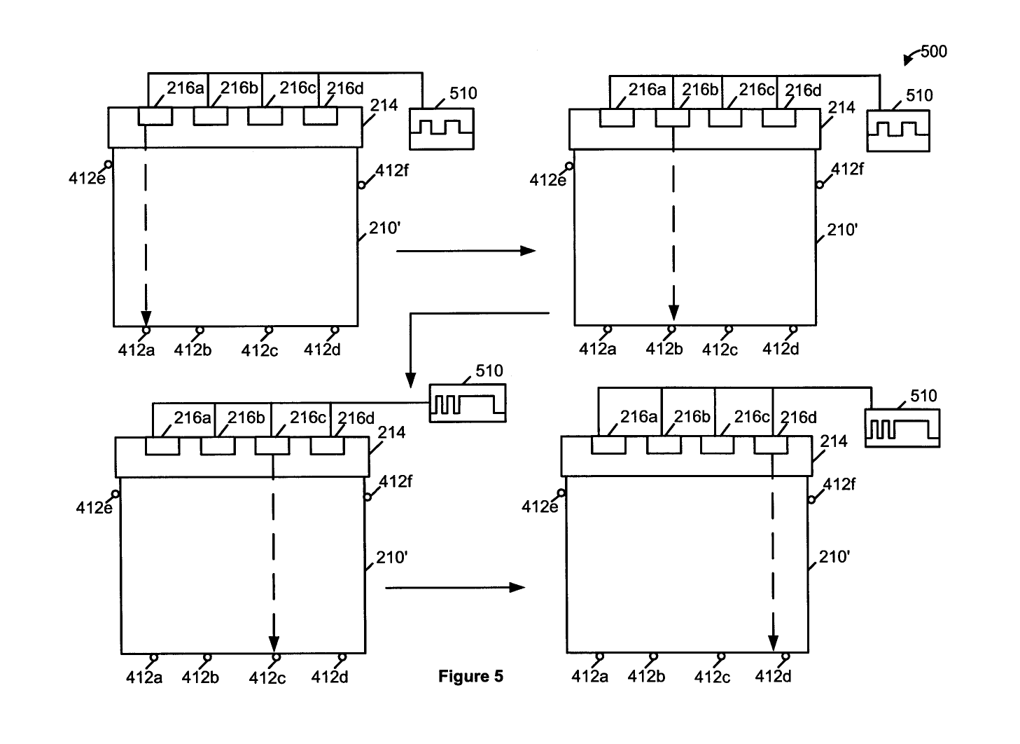

In some embodiments, ambient light noise may leak into the T-FLU 202 and/or optical artifacts that may occur upon the application of the pressure may reduce the change in intensity of the light and/or the deflected version of the light. If the noise or artifacts are too great relative to the applied pressure and/or the sensing capability of the system, the touch-screen capability may be reduced. Accordingly, embodiments of the T-FLU 210′ and/or method 500, such as those described with reference to FIGS. 4 and 5, respectively, may be employed for enhanced performance.

FIG. 4 is a schematic diagram of a touch-sensitive display apparatus in accordance with another embodiment of the invention. In various embodiments, the use of additional sensors 412a, 412b, 412c, 412d, 412e, 412f such as that described with reference to FIG. 4 may be used in order to process the light and deflected light according to interchannel differential signaling. In this regard, a small change in light intensity relative to a sizable noise or artifact environment may be detected and processed.

In the embodiment shown, T-FLU 400 may include a waveguide 210′, a light source module 214, a sensor module 410 and six sensors 412a, 412b, 412c, 412d, 412e, 412f communicatively coupled to the sensor module 410. As shown, the six sensors 412a, 412b, 412c, 412d, 412e, 412f provide resolution that is higher than that of the two sensor embodiment of FIGS. 2A and 2B. Each sensor may create a sensing channel that may be detected by the respective sensor. For example, the sensors 412e, 412f may be mounted on respective upper corners of the waveguide 210′ adjacent the light source module 214 while four sensors 412a, 412b, 412c, 412d may be mounted on the edge of the waveguide 210′ opposite the light source module 214.

In this embodiment, the T-FLU 400 may have a sensing area that may be virtually divided into any number of areas 212a, 212b of a grid. In the example shown, the T-FLU 400 is virtually divided into a 4 row×4 column grid. In other embodiments, the T-FLU 400 may be a grid of any number of rows and columns as dictated by the number of light sources and the number of detectors of the T-FLU 400. As the number of rows and/or columns of the grid of the T-FLU 400 increases, the resolution of the T-FLU 400 may increase. Accordingly, the different embodiments of the T-FLU 400 may be designed to achieve selected resolutions suitable for different applications.

In one embodiment, the sensors 412a, 412b, 412c, 412d, 412e, 412f may be photodetectors such as photodiodes. The sensors 412a, 412b, 412c, 412d, 412e, 412f may be positioned at any location along the periphery of the waveguide 210′ such that the sensors are able to detect the light emitted by the light sources 216a, 216b, 216c, 216d. Accordingly, the position of the sensors 412a, 412b, 412c, 412d, 412e, 412f may differ across embodiments based on the aspect ratio of the waveguide 210′ in cases when the light sources 216a, 216b, 216c, 216d are uniformly distributed across the edge of the waveguide 210′. In some embodiments, the light source module 214 may be or include a single discrete unit or an array of light sources 216a, 216b, 216c, 216d. In various embodiments, sensors 412a, 412b, 412c, 412d, 412e, 412f may be positioned at any number of angles relative to the sensor module 410 such that one or more of the sensors can sense light 224. In the embodiment shown, the angles 414a, 414b at which sensors 412a, 412d may be positioned may be any angle between approximately 5 degrees and 90 degrees.

Additional sensors may be placed along the waveguide 210′ depending on factors such as the geometry of the waveguide 210′, including, but not limited to, the aspect ratio of the waveguide 210′, the type and physical configuration of the light source module 214 or light sources therein, the geometrical arrangement of the entire set of sensors and/or the type or strength of the sensors and/or the signal processor.

The sensors 412a, 412b, 412c, 412d and/or the signal processor 220 may be able to normalize the non-uniform light that may be injected into the waveguide 202 and provide a substantially uniform output indicative of the situs and/or the measurement of the applied pressure.

In some embodiments, the light source module 214 may include a plurality of light sources 216a, 216b, 216c, 216d configured to emit light such as the light 224 emitted from light source 216b. In other embodiments, the light source module 214 may be any source configured to emit light. In various embodiments, the light sources 216a, 216b, 216c, 216d may be any mechanism configured to emit light that may be detected by sensors 412a, 412b, 412c, 412d, 412e, 412f. By way of example, but not limitation, one or more of the light sources 216a, 216b, 216c, 216d may be light visible or invisible to the human eye including, but not limited to, an LED, an infrared light source, an incandescent light, a fluorescent lamp, and/or an electroluminescent panel.

In various embodiments, the waveguide 210′ may be deformable. As noted above, in various embodiments, the waveguide 210′ may include transparent, substantially transparent plastic or flexible material. Also, as noted above, in other embodiments, any micropattern, including any number of shapes, may be fabricated as part of the waveguide 210′.

The waveguide 210′ may be coupled to the edge-mounted light source module 214 such that edge-injected light emitted from the light source module 214 may travel into the waveguide 210′. The sensors 412a, 412b, 412c, 412d, 412e, 412f may be operably coupled to and positioned along the waveguide 210′ such that one or more of the light emitted into the waveguide 210′ may be detected.

The T-FLU 400 may process the change in intensity of the light emitted by light sources 216a, 216b, 216c, 216d, or the deflected version of the light, according to interchannel differential signaling.

FIG. 5 is a flow diagram of a method of operating a touch-sensitive display apparatus in accordance with embodiments of the invention. Method 500 may operate on a T-FLU having a waveguide 210′ coupled to a light source module 214 and having a plurality of sensors 412a, 412b, 412c, 412d disposed on a first edge of the waveguide 210′, a sensor 412e on a second edge of the waveguide 210′ and a sensor 412f on a third edge of the waveguide 210′. In some embodiments, the light source module 214 may be adapted to output light to the waveguide 210′. In some embodiments, the light source module 214 may include light sources 216a, 216b, 216c, 216d.

In one embodiment, method 500 includes providing a signal controller 510 for controlling the light source module 214 to cause light source module 214 to output a modulated light to the T-FLU 210′. In two embodiments, the modulated light may be modulated according to Pulse Frequency Modulation (PFM) or Pulse Width Modulation (PWM). In the embodiment shown, in steps 1 and 2, the modulated light may be modulated according to PFM while, in steps 3 and 4, the modulated light may be modulated according to PWM.

Information may be transmitted to the signal processor (not shown) and/or to one or more of the sensors 412a, 412b, 412c, 412d, 412e, 412f about time periods during which any of the one or more sensors should receive a light, based on the characteristics of the modulation employed. The signal processor and/or sensors 412a, 412b, 412c, 412d, 412e, 412f may reject or filter out light or deflect light received during other time periods. Accordingly, the contribution sensed from ambient light at a sensor and/or processed at the signal processor 220 may be disregarded if sensed during a time period when no light or deflected light was provided from a light source to which the sensor is assigned to provide detection.

In some embodiments, the PFM may have a sufficiently high frequency such that the pulse is undetectable to the human eye. In various embodiments, the frequency may be 60 Hertz or higher. Further, PFM and/or PWM may be used to reduce noise interference between the light detected by the sensors 412a, 412b, 412c, 412d, 412e, 412f in the T-FLU 210′.

In another embodiment of method 500, a signature (e.g., pulse train) may be provided by the signal controller 510 to the light source module 214. The signature may be applied to any light emitted by the light source module 214. The sensors and/or the signal processor 220 may receive information about the signature and filter out light and/or deflected light that do not include the signature. Accordingly, ambient light noise that is sensed may be filtered out as it will not contain the signature, which is applied at the light source module 214. Additionally light and/or deflected light from light sources that are not controlled to apply the signature to emitted light at a selected time will also be filtered out. Accordingly, noise interference from other light sources in the waveguide 210′ may also be filtered out. For example, if a pulse train is provided on the light, information received during a time sample when no pulse is provided may be assumed to be ambient light or other noise, and filtered out.

In another embodiment, sequencing of the light emitted may be controlled by the signal controller 510. The signal controller 510 may control the light source module 214 to output a light from only one or more of selected light sources 216a, 216b, 216c, 216d in a selected order. The order may be sequential, random or otherwise. In some embodiments, more than one light source may be controlled to emit light simultaneously or concurrently.

As shown in FIG. 5, in step 1 of method 500, the light source module 214 outputs a light from light source 216a to sensor 412a. In step 2 of method 500, the light source module 214 outputs a light from light source 216b to sensor 412b. In step 3 of method 500, the light source module 214 outputs a light from light source 216c to sensor 412c. In step 4 of method 500, the light source module 214 outputs a light from light source 216d to sensor 412d. Information about which of the light sources 216a, 216b, 216c, 216 that is turned on or off at a selected time sample may be provided to the respective sensor and/or to the signal processor (not shown). Accordingly, the sensor and/or signal processor algorithm performed by the signal processor may filter out light and/or deflected light from other light sources (or from ambient light).

In various embodiments of method 500, any combination of modulation, signature application and/or light sequencing may also be applied concurrently, simultaneously and/or in series.

In various embodiments, the apparatus of FIG. 4 and the methods of FIG. 5 may improve performance with ambient light noise and optical artifacts and/or decrease the likelihood of interference from other light sources. Thus, identification of the situs and/or measurement of the pressure applied to the waveguide 210′ may be improved.

In the preceding specification, various embodiments of systems, apparatus and methods have been described with reference to the accompanying drawings. However, it will be evident that various modifications and/or changes may be made thereto, and/or additional embodiments may be implemented, without departing from the broader scope of the invention as set forth in the claims that follow. It is further noted that the figures illustrate various components as separate entities from one another. The illustration of components as separate entities from one another is merely exemplary. The components may be combined, integrated, separated and/or duplicated to support various applications. The specification and/or drawings are accordingly to be regarded in an illustrative rather than restrictive sense.

It is understood that the apparatus may include one or more additional apparatus, some of which are explicitly shown in the figures and/or others that are not. As used herein, the term “module” may be understood to refer to computing software, firmware, hardware, circuitry and/or various combinations thereof. It may be noted that the modules are merely exemplary. The modules may be combined, integrated, separated, and/or duplicated to support various applications. Also, a function described herein as being performed at a particular module may be performed at one or more other modules instead of or in addition to the function performed at the particular module shown. Further, the modules may be implemented across multiple devices and/or other components local or remote to one another. Additionally, the modules may be moved from one device and/or added to another device, and/or may be included in both devices.

It should also be noted that although the flow chart provided herein shows a specific order of method steps, it is understood that the order of these steps may differ from what may be depicted. Also two or more steps may be performed concurrently or with partial concurrence. Such variation will depend on the software and/or hardware systems chosen and/or on designer choice. It is understood that all such variations are within the scope of the exemplary embodiments. Likewise, software and/or web implementations of the exemplary embodiments could be accomplished with standard programming techniques with rule based logic and/or other logic to accomplish the various steps.

What is claimed is:

1. A touch-sensitive apparatus comprising:
a light source module configured to emit light;
a deformable waveguide coupled to the light source module and configured to transmit the light or a deflected version of the light at a situs at which pressure external to the deformable waveguide is applied, the deformable waveguide also being illuminated by the light; and
one or more sensors configured to detect information indicative of the light or the deflected version of the light at the situs and output a signal in response to the detected information.

2. The apparatus of claim 1, wherein the detected information is a change in intensity or angle of the light, or of the deflected version of the light, at the situs.

3. The apparatus of claim 1, wherein each of the one or more sensors are mounted along an edge of the deformable waveguide that is opposite the light source module.

4. The apparatus of claim 1, wherein a first plurality of the one or more sensors are mounted along an edge of the deformable waveguide that is opposite the light source module, and a second plurality of the one or more sensors are mounted along a plurality of corners of the deformable waveguide, wherein the plurality of corners are adjacent the light source module.

5. The apparatus of claim 1, wherein the one or more sensors are mounted along a plurality of corners of the deformable waveguide, wherein the plurality of corners are adjacent the edge of the deformable waveguide opposite the light source module.

6. The apparatus of claim 1, wherein the light source module comprises a plurality of light sources.

7. The apparatus of claim 6, wherein each of the plurality of light sources is a light emitting diode.

8. The apparatus of claim 1, wherein each of the sensors is a photodiode.

9. The apparatus of claim 1, wherein the deformable waveguide comprises polydimethylsiloxane.

10. The apparatus of claim 1, further comprising a signal processor configured to receive the signal output by the one or more of the sensors and identify the situs at which the external pressure is applied.

11. The apparatus of claim 10, further comprising a display device configured to provide a visual display indicative of the identified situs.

12. A touch-sensitive system comprising:
a touch-sensitive apparatus comprising:
a light source module configured to emit light;
a deformable waveguide coupled to the light source module and configured to transmit the light or a deflected version of the light at a situs at which pressure external to the deformable waveguide is applied, the deformable waveguide also being illuminated by the light; and
one or more sensors configured to detect information indicative of the light or the deflected version of the light at the situs and output a signal in response to the detected information;
a signal processor configured to receive the signal output by the one or more sensors and identify the situs; and
a display device configured to provide a visual display indicative of the identified situs.

13. The system of claim 12, wherein the detected information is a change in intensity or angle of the light, or of the deflected version of the light, at the situs.

14. The system of claim 12, wherein each of the one or more sensors is mounted along an edge of the deformable waveguide that is opposite the light source module.

15. The system of claim 12, wherein a first plurality of the one or more sensors is mounted along an edge of the deformable waveguide opposite the light source module, and a second plurality of the one or more sensors is mounted along a plurality of corners of the deformable waveguide, wherein the plurality of corners are adjacent the light source module.

16. The system of claim 12, wherein the one or more sensors are mounted along a plurality of corners of the deformable waveguide, wherein the plurality of corners are adjacent the edge of the deformable waveguide opposite the light source module.

17. The system of claim 12, wherein the deformable waveguide comprises polydimethylsiloxane.

18. The system of claim 12, further comprising a signal controller configured to control the light source module to selectively emit the light.

19. The system of claim 12, further comprising a signal controller configured to control the light source module to emit the light with a selected signature.

20. The system of claim 12, further comprising a signal controller configured to modulate the emitted light.

21. The system of claim 20, wherein the modulation is pulse frequency modulation.

22. The system of claim 20, wherein the modulation is pulse width modulation.

23. A method of operating a touch-sensitive apparatus having a light source module, a deformable waveguide coupled to the light source module, and one or more sensors coupled to the deformable waveguide, the method comprising:
emitting light from the light source module;
transmitting, through the deformable waveguide, the light or a deflected version of the light at a situs at which pressure external to the deformable waveguide is applied;
detecting, at the one or more sensors, information indicative of the light or the deflected version of the light at the situs; and
outputting, from the one or more sensors, a signal in response to the detected information.

24. The method of claim 23, wherein emitting light is performed according to a selected sequence.

25. The method of claim 24, wherein the light source module comprises a plurality of light sources and the selected sequence comprises emitting light from a sequential order of the light sources.

26. The method of claim 24, wherein the light source module comprises a plurality of light sources and the selected sequence comprises concurrently emitting light from one or more of the plurality of the light sources.

27. The method of claim 24, wherein the emitted light is modulated.

28. The method of claim 27, wherein the modulation is pulse frequency modulation.

29. The method of claim 27, wherein the modulation is pulse width modulation.

30. The method of claim 24, wherein detecting information and outputting a signal is performed at a selected one of the one or more sensors corresponding to a light source from which the light is emitted.

31. The method of claim 24, wherein the emitted light comprises a signature having a first portion corresponding to a first time period during which the emitted light should be detected and a second portion corresponding to a second time period during which the emitted light should not be detected.

32. The method of claim 31, further comprising filtering out a portion of the signal corresponding to the second time period and processing a portion of the signal corresponding to the first time period.
